(19) United States
(12) Patent Application Publication
(10) Pub. No.: US 2026/0251888 A1
(43) Pub. Date: Aug. 27, 2026

(54) PRISM ANTI-SHAKE MECHANISM AND CAMERA MODULE

(71) Applicant: AAC Optics (Nanning) Co., Ltd., Nanning (CN)

(72) Inventors: Zhiqiang Xu, Nanning (CN); Aixin Xu, Nanning (CN)

(21) Appl. No.: 19/538,918

(22) Filed: Feb. 12, 2026

(30) Foreign Application Priority Data
Feb. 21, 2025 (CN) 202510198993.6
Jan. 14, 2026 (CN) 202610049085.5

(51) Int. Cl. G02B 13/00; G02B 27/64; H04N 23/55; H04N 23/68

(52) U.S. Cl. CPC G02B 13/0065; G02B 27/646; H04N 23/55; H04N 23/68; H04N 23/6812; H04N 23/685; H04N 23/687

(57) ABSTRACT

Provided are a prism anti-shake mechanism and a camera module. The prism anti-shake mechanism includes a base, a prism carrier rotatably disposed to the base, a prism group fixed to the prism carrier, a holder, and a driving member. The prism anti-shake mechanism further includes at least two balls and a connecting assembly; the holder includes first and second tracks; the prism carrier includes third and fourth tracks which are parallel to each other in their extending directions and spaced apart from each other; the prism group is mounted in a mounting groove; the two balls are respectively disposed in the first track and third track and in the second track and fourth track; when the prism carrier is subjected to a force, the driving member drives the prism carrier to move along a first or second direction. The prism anti-shake mechanism has a good anti-shake effect.

### CROSS-REFERENCE TO RELATED APPLICATION

The present application claims priority to Chinese Patent Application No. 202510198993.6, filed on February 21, 2025, and Chinese Patent Application No. 202610049085.5, filed on January 14, 2026, the contents of which are incorporated herein by reference in their entirety.

### TECHNICAL FIELD

The present disclosure relates to the field of camera technologies, and in particular, to a prism anti-shake mechanism and a camera module.

### BACKGROUND

Optical anti-shake for mobile phone cameras is a platform stabilization technology, intended to reduce the impact on imaging stability caused by handshakes or environmental influences during mobile phone photography, often leading to problems such as image blurring and distortion. In such cases, the camera’s optical anti-shake technology can play an important role. Optical anti-shake adopts a pure optical method to perform correction, and performs optical compensation for shakes. The camera’s optical anti-shake adopts a mechanical stabilizing device, with higher reliability, and the captured images are clearer and more natural.

In a prism anti-shake mechanism in the related art, it includes a base, an anti-shake mechanism disposed in the base, and a prism fixed to the anti-shake mechanism. The anti-shake mechanism has a complex structure, making its manufacture and assembly more difficult, and usually adopts a structure of spring sheets plus balls. The spring sheets have the risk of fracture and deformation leading to anti-shake failure. Meanwhile, the anti-shake mechanism uses the same mechanism as a rotation center for anti-shake in two directions, leading to crosstalk during the anti-shake process in the two directions, thus reducing the anti-shake effect.

The technical problem to be solved by the present disclosure is to provide a prism anti-shake mechanism with a good anti-shake effect.

In order to solve the above technical problem, in a first aspect, an embodiment of the present disclosure provides a prism anti-shake mechanism, including a base with an accommodating space, a prism carrier rotatably disposed in the base, a prism group fixed to the prism carrier, a holder fixed at a side of the base away from the prism carrier, and a driving member configured to drive the prism carrier to rotate, where the driving member is fixed to a side of the base close to the prism carrier; where the prism anti-shake mechanism further includes at least two balls and a connecting assembly that provides a restoring force for the prism carrier during its movement;

the holder includes a holder body fixed to the base, and a first track and a second track formed by recessing into the holder body from a side of the holder body close to the prism carrier; the first track and the second track are parallel to each other in their extending directions and spaced apart from each other, and two ends of the connecting assembly are respectively connected to the holder body and the prism carrier; it is defined that an extending direction of a chord of an arc segment on which the first track is located is a first direction; and

the prism carrier includes a carrier body, a mounting groove formed by recessing from the carrier body, and a third track and a fourth track formed by recessing into the carrier body from a side of the carrier body close to the holder; the third track and the fourth track are parallel to each other in their extending directions and spaced apart from each other; the prism group is mounted in the mounting groove; it is defined that an extending direction of a chord of an arc segment on which the third track is located is a second direction, and the first direction and the second direction are perpendicular to each other; one of the two balls is disposed in the first track and the third track respectively, and the other ball is disposed in the second track and the fourth track respectively; and when the prism carrier is subjected to a force, the driving member drives the prism carrier to move along the first direction or the second direction.

As an improvement, the first track and the second track are arranged side by side along the first direction; and the third track and the fourth track are arranged in a staggered manner along the first direction.

As an improvement, the prism anti-shake mechanism further includes a fifth track formed by recessing into the carrier body from the side of the carrier body close to the holder; and the fifth track is arranged side by side with the third track along the second direction, the third track and the fifth track are respectively disposed opposite to the first track, and the fourth track is located between the third track and the fifth track along the first direction; and

the balls include three balls, where two of the balls are respectively disposed in the first track and the third track and in the second track and the fourth track; and a third one of the balls is disposed in the fifth track and the first track.

As an improvement, the prism anti-shake mechanism further includes a fifth track and a sixth track formed by recessing into the carrier body from the side of the carrier body close to the holder; and the sixth track is arranged side by side with the fourth track along the second direction, the sixth track is arranged side by side with the fifth track along the first direction, and the fourth track is arranged side by side with the third track along the first direction; and

the balls include four balls, where two of the balls are respectively disposed in the first track and the third track and in the first track and the fifth track; and the other two balls are respectively disposed in the second track and the fourth track and in the second track and the sixth track.

As an improvement, the holder further includes a first arc-shaped portion and a second arc-shaped portion formed by protruding and extending from the side of the holder body close to the prism carrier; and the first track and the second track are respectively formed by recessing inward from the first arc-shaped portion and the second arc-shaped portion; and

the prism carrier further includes a mounting portion formed by protruding from the carrier body toward a side close to the holder; and the third track, the fourth track, the fifth track, and the sixth track are respectively formed on the mounting portion.

As an improvement, the connecting assembly includes a magnetic attraction magnet and a magnetic pole piece, the magnetic attraction magnet and the magnetic pole piece are opposed to each other and spaced apart, the magnetic pole piece is located between the first track and the second track, and the magnetic attraction magnet is located between the third track and the fourth track; and the magnetic pole piece is fixed to a side of the holder body close to the carrier body, and the magnetic attraction magnet is fixed to a side of the carrier body close to the holder body.

As an improvement, the first track and the second track are arranged in a staggered manner along the first direction; and the third track and the fourth track are arranged side by side along the second direction.

As an improvement, the prism anti-shake mechanism further includes a fifth track formed by recessing into the holder body from the side of the holder body close to the prism carrier; and the fifth track is arranged side by side with the second track along the first direction, the second track and the fifth track are respectively disposed opposite to the fourth track, and the first track is located between the second track and the fifth track along the second direction; and

the balls include three balls, where two of the balls are respectively disposed in the first track and the third track and in the second track and the fourth track; and the other ball is disposed in the fourth track and the fifth track.

As an improvement, the driving member includes a first driving assembly and a second driving assembly; the first driving assembly and the second driving assembly are respectively fixed at two adjacent sides of the prism carrier; and the first driving assembly is configured to drive the prism carrier to move along the first track, and the second driving assembly is configured to drive the prism carrier to move along the third track.

As an improvement, the first driving assembly includes a first magnet fixed at a side of the prism carrier and a first driving coil fixed to the base, the first driving coil is provided opposite to the first magnet; and

the second driving assembly includes a second magnet fixed to an adjacent side of the prism carrier and a second driving coil fixed to the base, the second driving coil and the second magnet are oppositely disposed.

As an improvement, the base includes a base body, first side walls formed by bending and extending from two opposite sides of the base body to a side close to the prism carrier, as well as a second side wall and a third side wall formed by bending and extending from another two opposite sides of the base body to a side close to the prism carrier; the second side wall is provided with a first through groove penetrating therethrough, and the holder is mounted in the first through groove, and the first driving coil is fixed to a side of the first side wall close to the prism carrier, and the second driving coil is fixed to a side of the base body close to the prism carrier.

As an improvement, the prism anti-shake mechanism further includes a first lens, the first lens is fixed to the base, and an incident surface of the first lens is opposed to and spaced apart from an exit surface of the prism group.

As an improvement, the prism anti-shake mechanism further includes a second lens, the second lens is fixed to the base, and the second lens is disposed at an interval at a side of the first lens away from the prism carrier; and an exit surface of the first lens is opposite to an incident surface of the second lens, and a ray of light is emitted out of the base from an exit surface of the second lens; and the first lens and the second lens are located on a same optical axis.

As an improvement, the prism anti-shake mechanism further includes a fixing base, the fixing base is mounted on the base to form a sliding connection, and the second lens is fixed to the base.

As an improvement, the prism anti-shake mechanism further includes a third driving assembly, the third driving assembly includes a third driving coil and a third magnet; the third magnet is fixed to a side of the fixing base close to the base, the third driving coil is fixed to the base, the third driving coil is opposed to and spaced apart from the third magnet, and after the third driving coil is energized, the third driving coil drives the third magnet to move along a direction of the optical axis to achieve focusing.

As an improvement, the prism anti-shake mechanism further includes a sensor, and the sensor is disposed at an interval at a side of the second lens away from the first lens.

As an improvement, the prism anti-shake mechanism further includes a circuit board, the circuit board is fixed to an outer side of the base, and the circuit board is electrically connected to the driving member and the third driving assembly respectively.

In a second aspect, an embodiment of the present application further provides a camera module, including the prism anti-shake mechanism as described above.

Compared with the related art, in the prism anti-shake mechanism of the present disclosure, the prism carrier is disposed on the base for mounting the prism, the holder is disposed on the side of the base away from the prism carrier, and the driving member is fixed to the side of the base close to the prism carrier for driving the prism carrier to rotate; the prism anti-shake mechanism further includes at least two balls and the connecting assembly that provides the restoring force for the prism carrier during movement; the first track and the second track are disposed on the holder, and the third track and the fourth track are disposed on the prism carrier; one of the two balls is respectively disposed in the first track and the third track, and the other ball is respectively disposed in the second track and the fourth track; when the prism carrier is subjected to a force, the driving member drives the prism carrier to move along the first direction or the second direction; the first track and the third track as well as the second track and the fourth track achieve the position limiting of the prism carrier during movement, and by cooperating with the two balls, crosstalk between the two directions during the anti-shake process can be avoided; meanwhile, the structure formed by the tracks and the balls is more reliable and has better performance, and meanwhile, anti-shake failure caused by deformation or fracture of spring sheets due to the use of spring sheets is avoided; this structure has fewer balls, and the balls are disposed in a single layer, resulting in fewer components and a smaller overall size, which conforms to a miniaturization development trend of mobile phone cameras; and the overall structure is simple and easy to assemble, avoiding related risks caused by a complex assembly process.

### BRIEF DESCRIPTION OF DRAWINGS

To more clearly illustrate the technical solutions in the embodiments of the present disclosure, the accompanying drawings required to be used in the description of the embodiments will be briefly introduced below. Obviously, the accompanying drawings in the following description are only some embodiments of the present disclosure. For those of ordinary skill in the art, other accompanying drawings can also be obtained based on these accompanying drawings without creative efforts, wherein:

FIG. 1 is a schematic diagram of a three-dimensional structure of a prism anti-shake mechanism according to Embodiment I of the present disclosure;

FIG. 2 is a schematic diagram 1 of the partially exploded structure of the prism anti-shake mechanism according to Embodiment I of the present disclosure;

FIG. 3 is a schematic diagram 2 of the partially exploded structure of the prism anti-shake mechanism according to Embodiment I of the present disclosure;

FIG. 4 is a cross-sectional view taken along line A-A in FIG. 1;

FIG. 5 is a structural schematic diagram of a base of a prism anti-shake mechanism according to Embodiment I of the present disclosure;

FIG. 6 is a structural schematic diagram of a holder of the prism anti-shake mechanism according to Embodiment I of the present disclosure;

FIG. 7 is a structural schematic diagram of a prism carrier of the prism anti-shake mechanism according to Embodiment I of the present disclosure; and

FIG. 8 is a partial exploded structural schematic diagram of three balls of the prism anti-shake mechanism according to Embodiment I of the present disclosure;

FIG. 9 is an exploded structural schematic diagram of the prism anti-shake mechanism according to Embodiment II of the present disclosure;

FIG. 10 is a structural schematic diagram of a holder of the prism anti-shake mechanism according to Embodiment II of the present disclosure;

FIG. 11 is a schematic diagram of a side-by-side arrangement mode defined in the prism anti-shake mechanism according to the embodiments of the present disclosure;

FIG. 12 is a schematic diagram of a staggered arrangement mode defined in the prism anti-shake mechanism according to the embodiments of the present disclosure;

In the figures:

100: prism anti-shake mechanism of Embodiment I; 1: base; 101: base body; 102: first side wall; 103: second side wall; 104: third side wall; 105: first through groove; 106: second through groove; 107: first through hole; 108: second through hole; 109: third through hole 2: prism carrier; 21: carrier body; 22: mounting groove; 23: mounting portion; 24: third track; 25: fourth track; 26: fifth track; 27: sixth track; 3: prism group; 4: holder; 41: holder body; 42: arc- shaped portion; 421: first arc-shaped portion; 422: second arc-shaped portion; 43: first track; 44: second track; 5: driving member; 51: first driving assembly; 511: first driving coil; 512: first magnet; 52: second driving assembly; 521: second driving coil; 522: second magnet; 6: ball; 7: connecting assembly; 71: magnetic attraction magnet; 72: magnetic pole piece; 8: first rotation axis; 9: first lens; 10: second lens; 11: fixing base; 12: third driving assembly; 121: third driving coil; 122: third magnet; 13: sensor; 14: circuit board; 15: housing; 16: second rotation axis;

200: prism anti-shake mechanism of Embodiment 2; 24a: third track; 25a: fourth track; 43a: first track; 44a: second track; 45a: fifth track.

### DESCRIPTION OF EMBODIMENTS

Technical solutions in embodiments of the present disclosure will be described clearly and completely below in connection with the drawings in the embodiments of the present disclosure. Obviously, the described embodiments are only a part of the embodiments of the present disclosure, not all of the embodiments. Based on the embodiments in the present disclosure, all other embodiments obtained by those of ordinary skill in the art without creative efforts shall fall within the protection scope of the present disclosure.

### Embodiment I

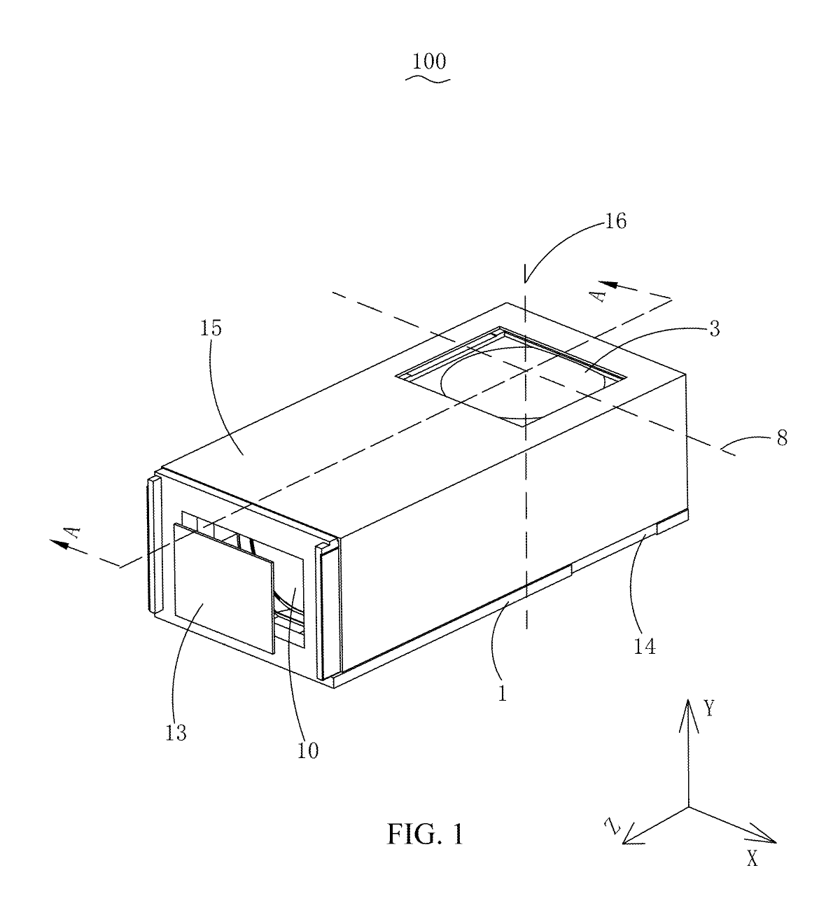

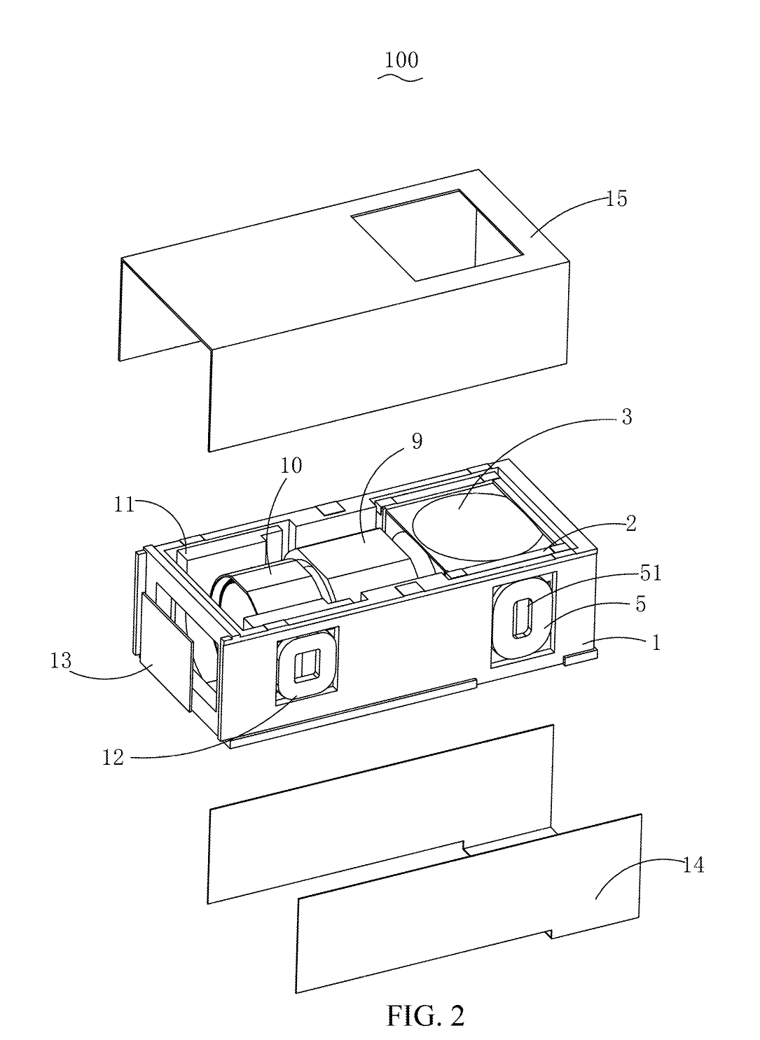

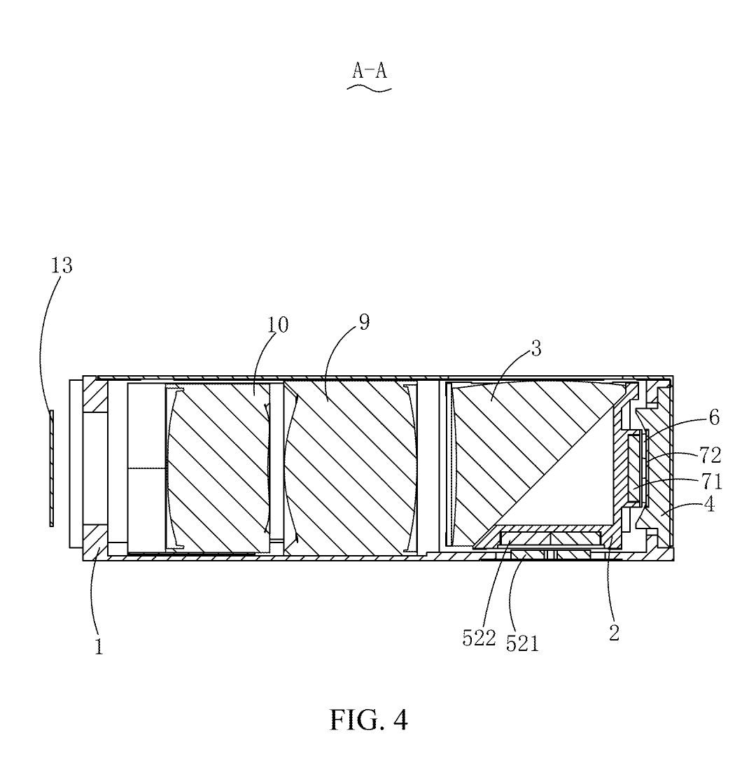

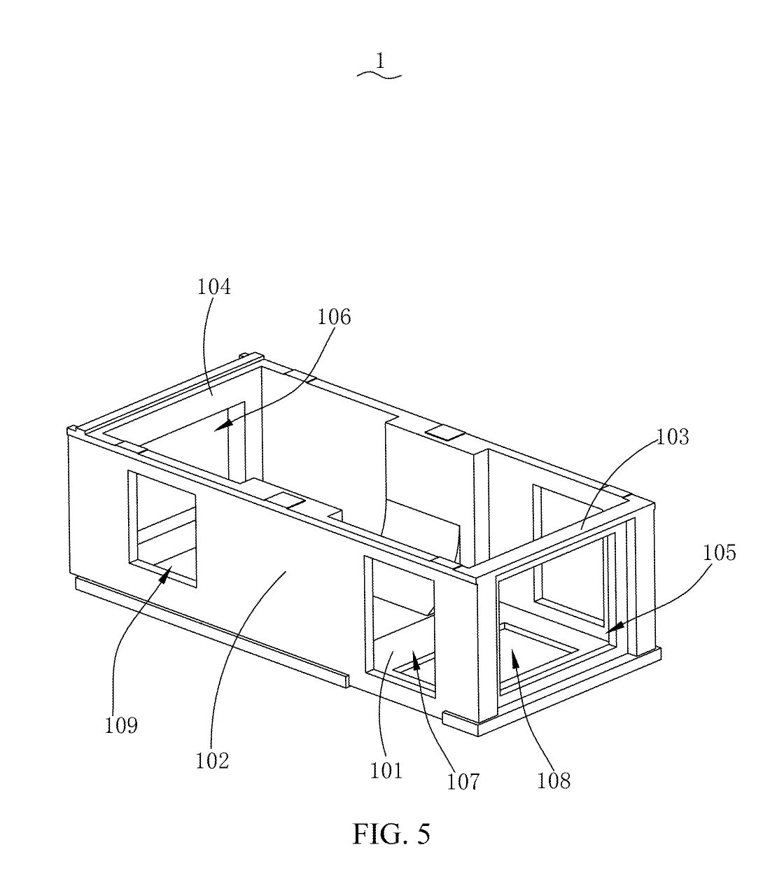

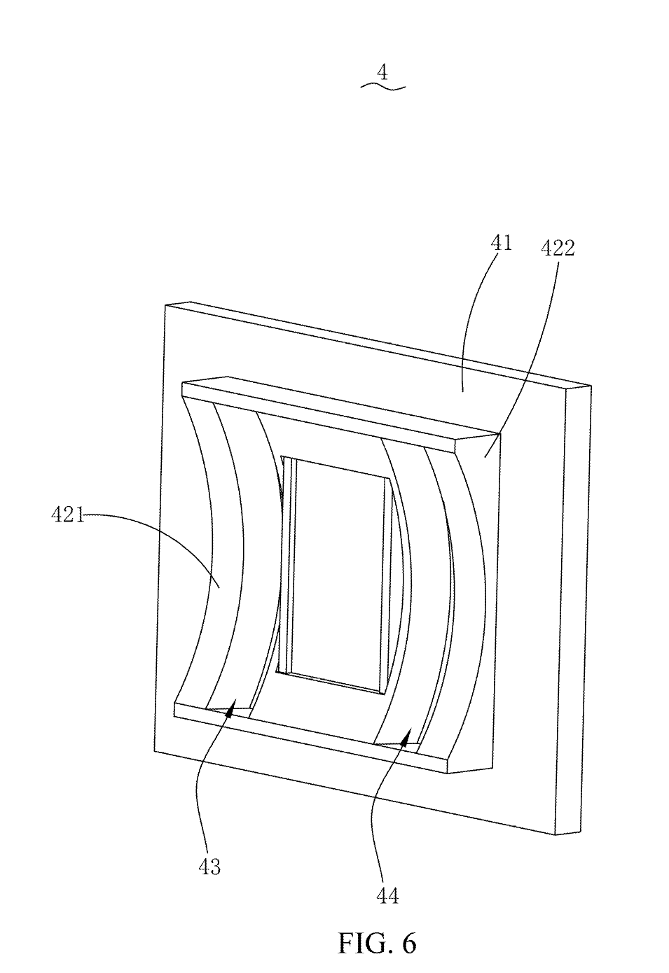

Referring to FIGS. 1-8 as shown, an embodiment of the present disclosure provides a prism anti-shake mechanism 100, including a base 1 with an accommodating space, a prism carrier 2 rotatably disposed to the base 1, a prism group 3 fixed to the prism carrier 2, a holder 4 fixed to a side of the base 1 away from the prism carrier 2, and a driving member 5 configured to drive the prism carrier 2 to rotate, where the driving member 5 is fixed to a side of the base 1 close to the prism carrier 2. The base 1 is configured to mount and dispose the prism carrier 2, the holder 4, and the driving member 5.

The prism anti-shake mechanism 100 further includes at least two balls 6 and a connecting assembly 7 that provides a restoring force for the prism carrier 2 during its movement.

The holder 4 includes a holder body 41 fixed to the base 1, and a first track 43 and a second track 44 formed by recessing into the holder body 41 from a side of the holder body 41 close to the prism carrier 2; the first track 43 and the second track 44 are parallel to each other in their extending directions and spaced apart from each other, and two ends of the connecting assembly 7 are respectively connected to the holder body 41 and the prism carrier 2; and it is defined that an extending direction of a chord of an arc segment on which the first track 43 is located is a first direction. Herein, the chord of the arc segment on which the first track 43 is located is a line connecting two endpoints of the arc segment.

The prism carrier 2 includes a carrier body 21, a mounting groove 22 formed by recessing from the carrier body 21, and a third track 24 and a fourth track 25 formed by recessing into the carrier body 21 from a side of the carrier body 21 close to the holder 4; the third track 24 and the fourth track 25 are parallel to each other in their extending directions and spaced apart from each other; and the prism group 3 is mounted in the mounting groove 22. It is defined that an extending direction of a chord of an arc segment on which the third track 24 is located is a second direction, and the first direction and the second direction are perpendicular to each other; one of the two balls 6 is disposed in the first track 43 and the third track 24 respectively, and the other ball 6 is disposed in the second track 44 and the fourth track 25 respectively. When the prism carrier 2 is subjected to a force, the driving member drives the prism carrier 2 to move along the first direction or the second direction. Herein, a second rotation axis 16 is parallel to the first direction, and a first rotation axis 8 is parallel to the second direction, where the second rotation axis 16 and the first rotation axis 8 are perpendicular to each other. In this embodiment, the first direction is a Y-axis direction and the second direction is an X-axis direction.

The connecting assembly 7 can provide a restoring force to the holder 4 and the prism carrier 2 to fix the balls 6. Through the first track 43 and the third track 24, as well as the second track 44 and the fourth track 25, position limiting of the prism carrier 2 is achieved during its movement, and by cooperating with the two balls 6, crosstalk between the two directions during the anti-shake process can be avoided. Meanwhile, the structure formed by the tracks and the balls 6 is more reliable and has better performance, and meanwhile, anti-shake failure caused by deformation or fracture of spring sheets due to the use of spring sheets is avoided. This structure has fewer balls 6, and the balls 6 are disposed in a single layer, resulting in fewer components and a smaller overall size, which conforms to a miniaturization development trend of mobile phone cameras. The overall structure is simple and easy to assemble, avoiding related risks caused by a complex assembly process.

Optionally, the first track 43 to the fourth track 25 are all arc-shaped track groove structures, facilitating the installation of the balls 6 and having a good rolling effect.

In this embodiment, the first track 43 and the second track 44 are arranged side by side along the first direction, and the third track 24 and the fourth track 25 are arranged in a staggered manner along the first direction. By arranging the first track 43 and the second track 44 side by side along the first direction, aligning the third track 24 directly with the first track 43, aligning the fourth track 25 directly with the second track 44, and arranging the third track 24 and the fourth track 25 in a staggered manner along the first direction, the two balls 6 can be provided to be spaced apart from each other along the second direction, enabling the prism carrier 2 to achieve a good movement effect. Optionally, the third track 24 and the fourth track 25 may also be arranged side by side along the first direction.

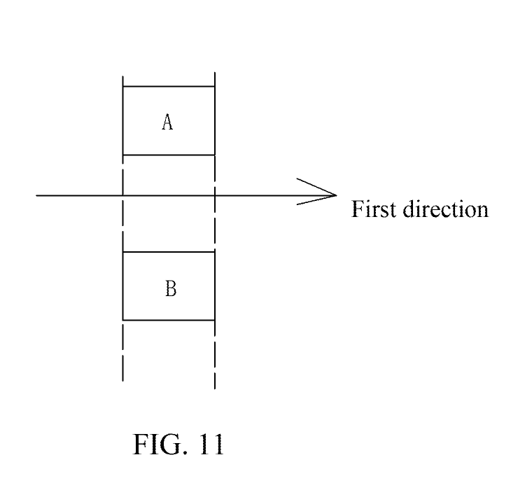

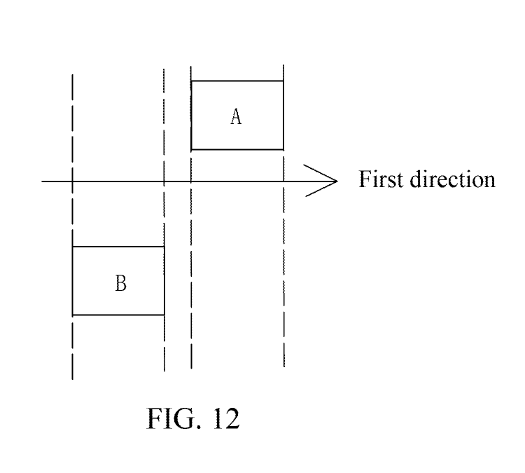

It should be noted that side-by-side or staggered arrangement is defined as follows in this embodiment: when defining side-by-side or staggered arrangement along a certain direction, with reference to FIG. 11, for example, two components A and B are provided in FIG. 11, and when the two components A and B are viewed along the first direction, the components A and B are in a same row, i.e., when the components A and B are respectively projected along a direction perpendicular to the first direction, a projection of the component A overlaps with a projection of the component B, whereby the components A and B are defined as being arranged side by side along the first direction. Further, as shown in FIG. 12, for example, two components A and B are provided in FIG. 12, when the two components A and B are viewed along the first direction, the components A and B are neither in a same row nor in a same column, i.e., when the components A and B are respectively projected along a direction perpendicular to the first direction, a projection of the component A has no overlapping part with a projection of the component B, and when the components A and B are respectively projected along the first direction, a projection of the component A has no overlapping part with a projection of the component B, whereby the components A and B are defined as being arranged in a staggered manner along the first direction.

In this embodiment, the prism anti-shake mechanism 100 further includes a fifth track 26 formed by recessing into the carrier body 21 from the side of the carrier body 21 close to the holder 4; the fifth track 26 is arranged side by side with the third track 24 along the second direction, the third track 24 and the fifth track 26 are respectively disposed opposite to the first track 43, and the fourth track 25 is located between the third track 24 and the fifth track 26 along the first direction.

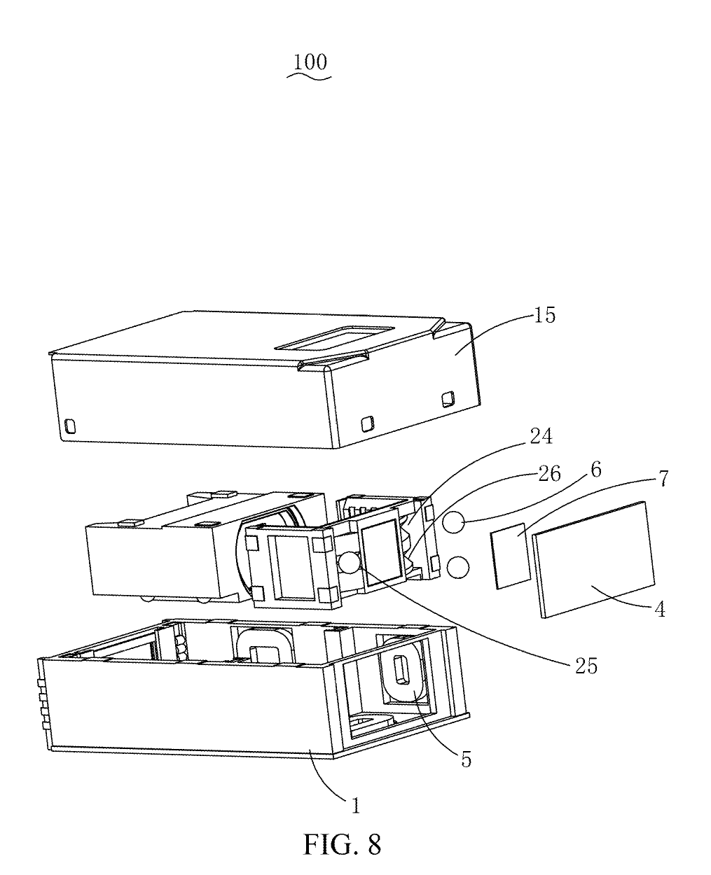

As shown in FIG. 8, the balls 6 include three balls, where two of the balls 6 are respectively disposed in the first track 43 and the third track 24, and in the second track 44 and the fourth track 25; the third ball 6 is disposed in the fifth track 26 and the first track 43. By using the third track 24, the fourth track 25, and the fifth track 26 together as the tracks for the second rotation axis, three balls 6 can be installed respectively, providing a good support effect for the balls 6 and ensuring good movement and anti-shake effects of the prism carrier 2.

In this embodiment, the prism anti-shake mechanism 100 further includes a fifth track 26 and a sixth track 27 formed by recessing into the carrier body 21 from the side of the carrier body 21 close to the holder 4; the sixth track 27 is arranged side by side with the fourth track 25 along the second direction, the sixth track 27 is arranged side by side with the fifth track 26 along the first direction, and the fourth track 25 is arranged side by side with the third track 24 along the first direction.

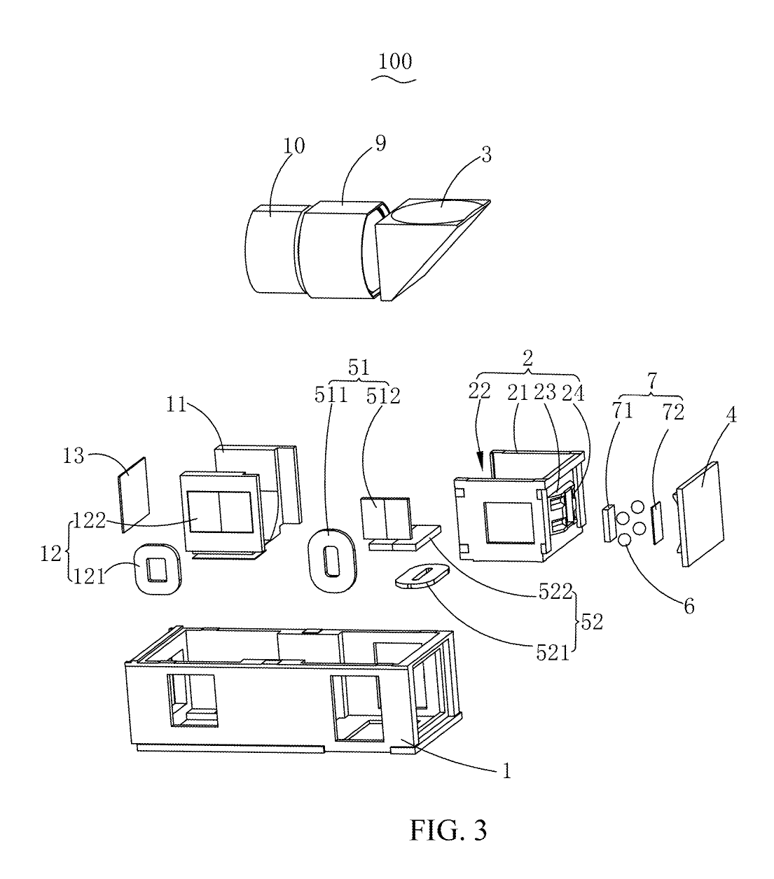

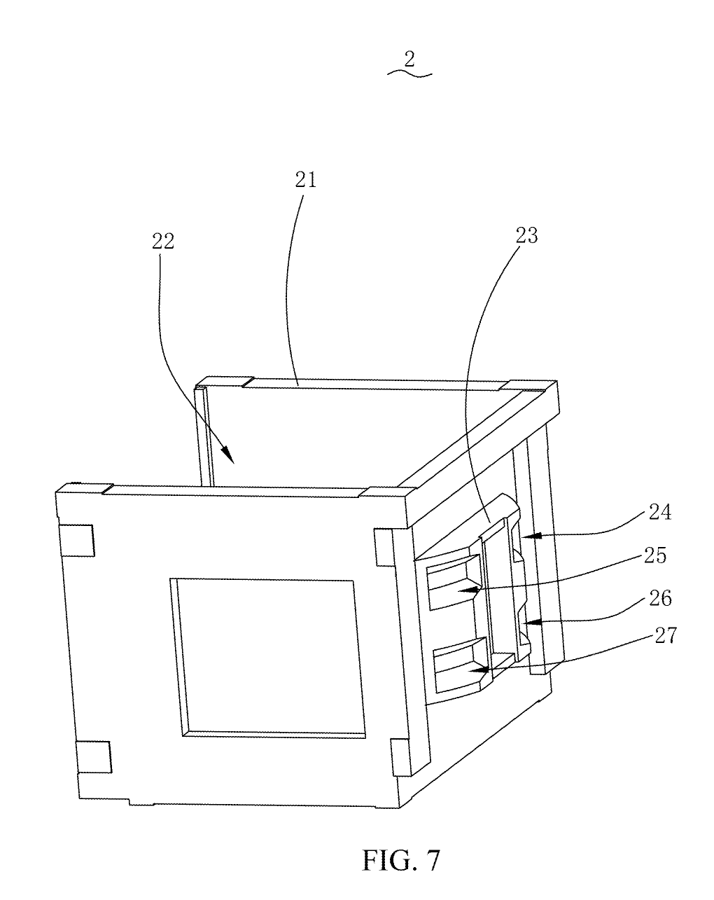

As shown in FIGS. 3 and 7, the balls 6 include four balls, where two of the balls 6 are respectively disposed in the first track 43 and the third track 24, and in the first track 43 and the fifth track 26; the other two balls 6 are respectively disposed in the second track 44 and the fourth track 25, and in the second track 44 and the sixth track 27. Specifically, by disposing the four balls 6 in the first track 43 and the second track 44 respectively (with two balls 6 in each track), and spacing the four balls 6 in pairs from each other along the first direction and the second direction, the contact area between the balls 6 and the first track 43 as well as the second track 44 is increased, thereby being capable of avoiding crosstalk between the two directions during the anti-shake process and resulting in an better anti-shake effect of the prism carrier 2 during movement.

In this embodiment, the holder 4 further includes a first arc-shaped portion 421 and a second arc-shaped portion 422 formed by protruding and extending from the side of the holder body 41 close to the prism carrier 2; the first track 43 and the second track 44 are respectively formed by recessing inward from the first arcuate portion 421 and the second arcuate portion 422. The prism carrier 2 further includes a mounting portion 23 formed by protruding from the carrier body 21 toward a side close to the holder 4; the third track 24, the fourth track 25, the fifth track 26, and the sixth track 27 are respectively formed on the mounting portion 23.

In this embodiment, the connecting assembly 7 includes a magnetic attraction magnet 71 and a magnetic pole piece 72; the magnetic attraction magnet 71 and the magnetic pole piece 72 are opposed to each other and spaced apart, the magnetic pole piece 72 is located between the first track 43 and the second track 44, and the magnetic attraction magnet 71 is located between the third track 24 and the fourth track 25; the magnetic pole piece 72 is fixed to the side of the holder body 41 close to the carrier body 21, and the magnetic attraction magnet 71 is fixed to the side of the carrier body 21 close to the holder body 41. Through the mutual magnetic attraction generated between the magnetic attraction magnet 71 and the magnetic pole piece 72, the first track 43 and the third track 24 are pressed close to each other to fix the balls 6 disposed therein, achieving a good position limiting effect for the balls 6, preventing the balls 6 from falling off during the movement of the prism carrier 2, and ensuring high safety.

In other embodiments, the connecting assembly 7 may also be implemented by an elastic member or the like, which will not be described in detail herein.

In this embodiment, the driving member 5 includes a first driving assembly 51 and a second driving assembly 52. The first driving assembly 51 and the second driving assembly 52 are respectively fixed at two adjacent sides of the prism carrier 2. The first driving assembly 51 is configured to drive the prism carrier 2 to move along the first track 43. The second driving assembly 52 is configured to drive the prism carrier 2 to move along the third track 24.

In this embodiment, the first driving assembly 51 includes a first magnet 512 fixed at a side of the prism carrier 2 and a first driving coil 511 fixed to the base 1. The first driving coil 511 is disposed opposite to the first magnet 512. There are two first magnets 512 and they are disposed side by side. The first magnets 512 are embedded in the prism carrier 2. Through mutual driving between the first driving coil 511 which is energized and the first magnets 512, the prism carrier 2 is driven to move along the first track 43 with the first rotation axis 8 as a rotation center, thereby realizing an anti-shake function in the first direction.

The second driving assembly 52 includes a second magnet 522 fixed to an adjacent side of the prism carrier 2 and a second driving coil 521 fixed to the base 1. The second driving coil 521 is disposed opposite to the second magnet 522. There are two second magnets 522 and they are disposed side by side. The second magnets 522 are embedded in the prism carrier 2. Through mutual driving between the second driving coil 521 which is energized and the second magnets 522, the prism carrier 2 is driven to move along the third track 24 with the second rotation axis 16 as a rotation center, thereby realizing an anti-shake function in the second direction.

In this embodiment, the base 1 includes a base body 101, first side walls 102 formed by bending and extending from two opposite sides of the base body 101 to a side close to the prism carrier 2, and a second side wall 103 and a third side wall 104 formed by bending and extending from another two opposite sides of the base body 101 to a side close to the prism carrier 2. The second side wall 103 is provided with a first through groove 105 penetrating therethrough. The holder 4 is installed in the first through groove 105. The first driving coil 511 is fixed to a side of the first side wall 102 close to the prism carrier 2, and the second driving coil 521 is fixed to a side of the base body 101 close to the prism carrier 2.

In this embodiment, the prism anti-shake mechanism 100 further includes a first lens 9 fixed to the base 1. An incident surface of the first lens 9 is opposed to and spaced apart from an exit surface of the prism group 3.

In this embodiment, the prism anti-shake mechanism 100 further includes a second lens 10 fixed to the base 1, and the second lens 10 is disposed at an interval at a side of the first lens 9 away from the prism carrier 2; an exit surface of the first lens 9 is opposite to an incident surface of the second lens 10, and a ray of light is emitted out of the base 1 from an exit surface of the second lens 10; and the first lens 9 and the second lens 10 are located on a same optical axis. Herein, the optical axis is a Z-axis direction.

In this embodiment, the prism anti-shake mechanism 100 further includes a fixing base 11, the fixing base 11 is mounted on the base 1 to form a sliding connection, and the second lens 10 is fixed to the base 1. By adjusting the moving position of the fixing base 11 to achieve the position of the second lens 10, thereby achieving the focusing function. Optionally, the fixing base 11 and the base 1 may alternatively form a rolling connection, achieving the same effect.

In this embodiment, the prism anti-shake mechanism 100 further includes a third driving assembly 12, and the third driving assembly 12 includes a third driving coil 121 and a third magnet 122; and the third magnet 122 is fixed to a side of the fixing base 11 close to the base 1, the third driving coil 121 is fixed to the base 1, and the third driving coil 121 is opposed to and spaced apart from the third magnet 122. After the third driving coil 121 is energized, it drives the third magnet 122 to move along a direction of the optical axis to achieve focusing, and both the first direction and the second direction are perpendicular to the optical axis. In this embodiment, the third side wall 104 is provided with a second through groove 106, the first side wall 102 is provided with a first through hole 107 and a third through hole 109 extending therethrough, and the base body 101 is formed with a second through hole 108 extending therethrough. The third driving assembly 12 is disposed in the second through groove 106, the first driving coil 511 is disposed in the first through hole 107, the second driving coil 521 is disposed in the second through hole 108, and the third driving coil 121 is disposed in the third through hole 109, thereby achieving good overall encapsulation.

In this embodiment, the prism anti-shake mechanism 100 further includes a sensor 13, and the sensor 13 is disposed at an interval at a side of the second lens 10 away from the first lens 9.

In this embodiment, the prism anti-shake mechanism 100 further includes a circuit board 14, the circuit board 14 is fixed to an outer side of the base 1, and the circuit board 14 is electrically connected to the driving member 5 and the third driving assembly 12 respectively. A side of the circuit board 14 away from the base 1 is used for connecting to an external power supply, facilitating the circuit board 14 to supply power to the first driving coil 511, the second driving coil 521, and the third driving coil 121 respectively.

Optionally, the circuit board 14 is an FPC (Flexible Printed Circuit) with excellent conductivity, a flexible structure, and convenient installation.

In this embodiment, the base 1 is manufactured by the Insert (Insert Molding) process, and the required circuit board 14 is disposed in the interior of the base 1 via the Insert molding process, so that the number of product components is reduced and assembly processes are saved.

### Embodiment II

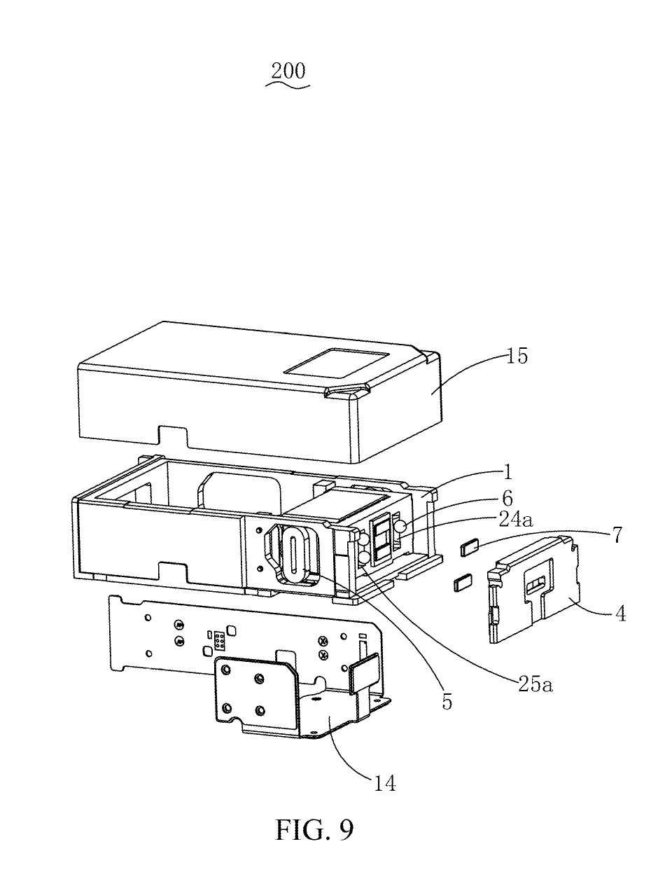

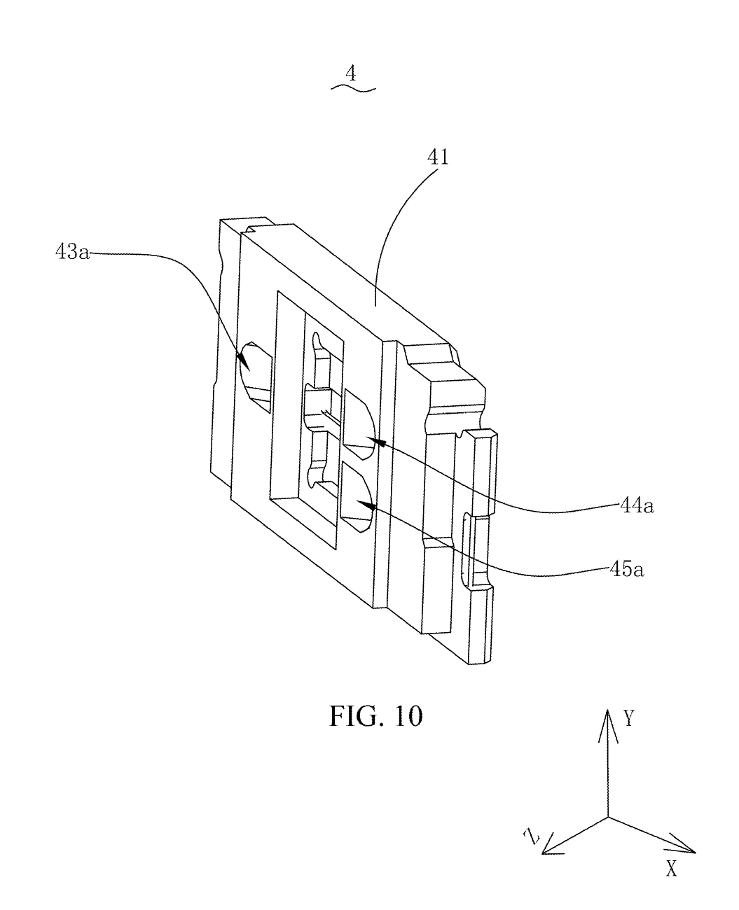

Referring to FIGS. 1 to 10, an embodiment of the present disclosure further provides a prism anti-shake mechanism 200. Embodiment II is substantially the same as Embodiment I, with the difference that the first track 43a and the second track 44a are arranged in a staggered manner along the first direction; and the third track 24a and the fourth track 25a are arranged side by side along the second direction. The second rotation axis 16 is parallel to the second direction, the first rotation axis 8 is parallel to the first direction, and the second rotation axis 16 and the first rotation axis 8 are perpendicular to each other. In this embodiment, the second direction is the Y-axis direction and the first direction is the X-axis direction.

In this embodiment, the prism anti-shake mechanism 200 further includes a fifth track 45a formed by recessing into the holder body 41 from a side of the holder body 41 close to the prism carrier 2; the fifth track 45a is arranged side by side with the second track 44a along the first direction, the second track 44a and the fifth track 45a are respectively arranged opposite to the fourth track 25a, and the first track 43a is located between the second track 44a and the fifth track 45a along the second direction.

The balls 6 include three balls, where two of the balls 6 are respectively disposed in the first track 43a and the third track 24a and in the second track 44a and the fourth track 25a; the other ball 6 is disposed in the fourth track 25a and the fifth track 45a. By using the three balls 6 as supports, the three support points can be kept coplanar at all times, reducing jitter or jumping of the prism carrier 2 during rotation.

Herein, the third track 24a and the fourth track 25a rotating around the first rotation axis 8 are provided on the prism carrier 2, which can reduce the overall rotation radius, thereby reducing the friction arm and the rotation amplitude of the magnetic attraction magnet 71 in the prism carrier 2, further reducing the magnetic restoring torque, thereby reducing the driving coil current, and thus reducing power consumption. At the same height of the prism carrier 2, the larger the corresponding arc of the third track 24a and the fourth track 25a rotating around the first rotation axis 8, the greater the component force of the magnetic attraction force in the second direction under the action of the magnetic attraction of the magnetic pole piece 72 in the holder 4, which can better resist the overturning of the prism carrier 2 in the second direction. By providing the first track 43a and the second track 44a rotating around the second rotation axis 16 on the holder 4, the space of the bracket 4 in the first direction is larger; two tracks, i.e., the second track 44a and the fifth track 45a, rotating around the second direction can be provided on one side, and the first track 43a rotating around the second direction can be provided on the other side, so that the balls 6 on the two sides can be spaced farther apart. In this way, the magnetic pole piece 72 in the holder 4 attracts the prism carrier 2, and the magnetic pole piece 72 in turn is better attached to the balls 6. By replacing the magnetic attraction magnet 71 rotating around the first direction in the prism carrier 2 with a Halbach magnet, the magnetic field is more concentrated on the coil side; thus, under the same current, the driving force of the coil is greater, which can reduce the driving current and thus reduce driving power consumption. By sharing three balls 6 in the tracks, the volume of the module can be reduced.

### Embodiment III

An embodiment of the present disclosure further provides a camera module, which includes the prism anti-shake mechanism as described in Embodiment 1 and Embodiment 2 above.

Compared with the related art, in the prism anti-shake mechanism of the present disclosure, the prism carrier is disposed on the base for mounting the prism, the holder is disposed on the side of the base away from the prism carrier, and the driving member is fixed to the side of the base close to the prism carrier for driving the prism carrier to rotate; the prism anti-shake mechanism further includes at least two balls and the connecting assembly that provides the restoring force for the prism carrier during movement; the first track and the second track are disposed on the holder, and the third track and the fourth track are disposed on the prism carrier; one of the two balls is respectively disposed in the first track and the third track, and the other ball is respectively disposed in the second track and the fourth track; when the prism carrier is subjected to a force, the driving member drives the prism carrier to move along the first direction or the second direction; the first track and the third track as well as the second track and the fourth track achieve the position limiting of the prism carrier during movement, and by cooperating with the two balls, crosstalk between the two directions during the anti-shake process can be avoided; meanwhile, the structure formed by the tracks and the balls is more reliable and has better performance, and meanwhile, anti-shake failure caused by deformation or fracture of spring sheets due to the use of spring sheets is avoided; this structure has fewer balls, and the balls are disposed in a single layer, resulting in fewer components and a smaller overall size, which conforms to a miniaturization development trend of mobile phone cameras; and the overall structure is simple and easy to assemble, avoiding related risks caused by a complex assembly process.

The above are only the embodiments of the present disclosure. It should be pointed out here that for those of ordinary skill in the art, improvements can also be made without departing from the inventive concept of the present disclosure, and these all fall within the protection scope of the present disclosure.

What is claimed is:

1. A prism anti-shake mechanism, comprising a base with an accommodating space, a prism carrier rotatably disposed to the base, a prism group fixed to the prism carrier, a holder fixed to a side of the base away from the prism carrier, and a driving member configured to drive the prism carrier to rotate, wherein the driving member is fixed to a side of the base close to the prism carrier; wherein the prism anti-shake mechanism further comprises at least two balls and a connecting assembly that provides a restoring force for the prism carrier during its movement;
the holder comprises a holder body fixed to the base, and a first track and a second track formed by recessing into the holder body from a side of the holder body close to the prism carrier; the first track and the second track are parallel to each other in their extending directions and spaced apart from each other, and two ends of the connecting assembly are respectively connected to the holder body and the prism carrier; it is defined that an extending direction of a chord of an arc segment on which the first track is located is a first direction; and
the prism carrier comprises a carrier body, a mounting groove formed by recessing from the carrier body, and a third track and a fourth track formed by recessing into the carrier body from a side of the carrier body close to the holder; the third track and the fourth track are parallel to each other in their extending directions and spaced apart from each other; the prism group is mounted in the mounting groove; it is defined that an extending direction of a chord of an arc segment on which the third track is located is a second direction, and the first direction and the second direction are perpendicular to each other; one of the two balls is disposed in the first track and the third track respectively, and the other ball is disposed in the second track and the fourth track respectively; and when the prism carrier is subjected to a force, the driving member drives the prism carrier to move along the first direction or the second direction.

2. The prism anti-shake mechanism as described in claim 1, wherein the first track and the second track are arranged side by side along the first direction; and the third track and the fourth track are arranged in a staggered manner along the first direction.

3. The prism anti-shake mechanism as described in claim 2, further comprising a fifth track formed by recessing into the carrier body from the side of the carrier body close to the holder; and the fifth track is arranged side by side with the third track along the second direction, the third track and the fifth track are respectively disposed opposite to the first track, and the fourth track is located between the third track and the fifth track along the first direction; and
the balls comprise three balls, wherein two of the balls are respectively disposed in the first track and the third track and in the second track and the fourth track; and a third one of the balls is disposed in the fifth track and the first track.

4. The prism anti-shake mechanism as described in claim 1, further comprising a fifth track and a sixth track formed by recessing into the carrier body from the side of the carrier body close to the holder; and the sixth track is arranged side by side with the fourth track along the second direction, the sixth track is arranged side by side with the fifth track along the first direction, and the fourth track is arranged side by side with the third track along the first direction; and
the balls comprise four balls, wherein two of the balls are respectively disposed in the first track and the third track and in the first track and the fifth track; and the other two balls are respectively disposed in the second track and the fourth track and in the second track and the sixth track.

5. The prism anti-shake mechanism as described in claim 4, wherein the holder further comprises a first arc-shaped portion and a second arc-shaped portion formed by protruding and extending from the side of the holder body close to the prism carrier; and the first track and the second track are respectively formed by recessing inward from the first arc-shaped portion and the second arc-shaped portion; and
the prism carrier further comprises a mounting portion formed by protruding from the carrier body toward a side close to the holder; and the third track, the fourth track, the fifth track, and the sixth track are respectively formed on the mounting portion.

6. The prism anti-shake mechanism as described in claim 1, wherein the connecting assembly comprises a magnetic attraction magnet and a magnetic pole piece, the magnetic attraction magnet and the magnetic pole piece are opposed to each other and spaced apart, the magnetic pole piece is located between the first track and the second track, and the magnetic attraction magnet is located between the third track and the fourth track; and the magnetic pole piece is fixed to a side of the holder body close to the carrier body, and the magnetic attraction magnet is fixed to a side of the carrier body close to the holder body.

7. The prism anti-shake mechanism as described in claim 1, wherein the first track and the second track are arranged in a staggered manner along the first direction; and the third track and the fourth track are arranged side by side along the second direction.

8. The prism anti-shake mechanism as described in claim 7, further comprising a fifth track formed by recessing into the holder body from the side of the holder body close to the prism carrier; and the fifth track is arranged side by side with the second track along the first direction, the second track and the fifth track are respectively disposed opposite to the fourth track, and the first track is located between the second track and the fifth track along the second direction; and
the balls comprise three balls, wherein two of the balls are respectively disposed in the first track and the third track and in the second track and the fourth track; and the other ball is disposed in the fourth track and the fifth track.

9. The prism anti-shake mechanism as described in claim 1, wherein the driving member comprises a first driving assembly and a second driving assembly; the first driving assembly and the second driving assembly are respectively fixed at two adjacent sides of the prism carrier; and the first driving assembly is configured to drive the prism carrier to move along the first track, and the second driving assembly is configured to drive the prism carrier to move along the third track.

10. The prism anti-shake mechanism as described in claim 9, wherein the first driving assembly comprises a first magnet fixed at a side of the prism carrier and a first driving coil fixed to the base, the first driving coil is provided opposite to the first magnet; and
the second driving assembly comprises a second magnet fixed to an adjacent side of the prism carrier and a second driving coil fixed to the base, the second driving coil and the second magnet are oppositely disposed.

11. The prism anti-shake mechanism as described in claim 10, wherein the base comprises a base body, first side walls formed by bending and extending from two opposite sides of the base body to a side close to the prism carrier, as well as a second side wall and a third side wall formed by bending and extending from another two opposite sides of the base body to a side close to the prism carrier; and the second side wall is provided with a first through groove penetrating therethrough, the holder is mounted in the first through groove, and the first driving coil is fixed to a side of the first side wall close to the prism carrier, and the second driving coil is fixed to a side of the base body close to the prism carrier.

12. The prism anti-shake mechanism as described in claim 1, further comprising a first lens, the first lens is fixed to the base, and an incident surface of the first lens is opposed to and spaced apart from an exit surface of the prism group.

13. The prism anti-shake mechanism as described in claim 12, further comprising a second lens, the second lens is fixed to the base, and the second lens is disposed at an interval at a side of the first lens away from the prism carrier; and an exit surface of the first lens is opposite to an incident surface of the second lens, and a ray of light is emitted out of the base from an exit surface of the second lens; and the first lens and the second lens are located on a same optical axis.

14. The prism anti-shake mechanism as described in claim 13, further comprising a fixing base, the fixing base is mounted on the base to form a sliding connection, and the second lens is fixed to the base.

15. The prism anti-shake mechanism as described in claim 14, further comprising a third driving assembly, the third driving assembly comprises a third driving coil and a third magnet; the third magnet is fixed to a side of the fixing base close to the base, the third driving coil is fixed to the base, the third driving coil is opposed to and spaced apart from the third magnet, and after the third driving coil is energized, the third driving coil drives the third magnet to move along a direction of the optical axis to achieve focusing.

16. The prism anti-shake mechanism as described in claim 13, further comprising a sensor, and the sensor is disposed at an interval at a side of the second lens away from the first lens.

17. The prism anti-shake mechanism as described in claim 15, further comprising a circuit board, the circuit board is fixed to an outer side of the base, and the circuit board is electrically connected to the driving member and the third driving assembly respectively.

18. A camera module, comprising the prism anti-shake mechanism as described in claim 1.
